(19) United States
(12) Patent Application Publication
(10) Pub. No.: US 2012/0106465 A1
(43) Pub. Date: May 3, 2012

(54) DOWNLINK CONTROL IN HETEROGENEOUS NETWORKS

(75) Inventors: Afshin Haghighat, Ile-Bizard (CA); Pascal M. Adjakple, Great Neck, NY (US); David S. Bass, Great Neck, NY (US); Mahmoud Watfa, Saint Leonard (CA); Mihaela C. Beluri, Huntington, NY (US); Guodong Zhang, Syosset, NY (US)

(73) Assignee: INTERDIGITAL PATENT HOLDINGS, INC., Wilmington, DE (US)

(21) Appl. No.: 13/098,022

(22) Filed: Apr. 29, 2011

Related U.S. Application Data
(60) Provisional application No. 61/329,608, filed on Apr. 30, 2010.

(51) Int. Cl. H04W 74/04; H04W 72/04

(52) U.S. Cl. 370/329

(57) ABSTRACT

Embodiments contemplate a wireless transmit/receive unit (WTRU) that may operate in a heterogeneous wireless communication network (HetNet). The WTRU may detect the presence of an extended physical downlink control channel (E-PDCCH) and may decode a physical downlink control channel (PDCCH) upon detecting the E-PDCCH. The WTRU may obtain scheduling information of the E-PDCCH on a physical downlink shared control channel (PDSCH) from the decoded PDCCH. The WTRU may also determine control information for the WTRU from the E-PDCCH using the scheduling information of the E-PDCCH. The HetNet may further include a first eNB and a second eNB and the WTRU may receive the E-PDCCH from the first eNB and another E-PDCCH from the second eNB. The other E-PDCCH may be coordinated with the E-PDCCH such that the interference between the other E-PDCCH and the E-PDCCH from the perspective of the WTRU may be reduced relative to no coordination.

### CROSS REFERENCE TO RELATED APPLICATIONS

This application claims the benefit of U.S. Provisional Application No. 61/329,608 filed Apr. 30, 2010, titled “Downlink Control in Heterogeneous Network”, the contents of which is hereby incorporated by reference herein in its entirety, for all purposes.

### BACKGROUND

In wireless networking, the term heterogeneous network may refer to wireless networks that have overlapping base stations, often with different power ranges, in the same spectrum. For example, a wireless network with a macro, or conventional bases station, in the same geographical area as a pico base station, femto base station, and/or relays that operate in the same spectrum (that generally may be referred to as home nodes or home base stations) may be considered a heterogeneous network. The macro base stations may operate at higher levels of power than the home base stations, for example.

Also, wireless transmit/receive devices, such as but not limited to, cell phones and base stations, may operate within heterogeneous networks in respective compliance with different versions (e.g., releases, or variations of releases) of wireless communication industry standards. By way of example, and not limitation, in a heterogeneous network—one or more base stations may operate in substantial compliance with Release 8 of the Third Generation Partnership Project (3GPP) standards, while other base stations may operate in substantial compliance with Release 10 of the 3GPP standards. Also by way of example, a mobile phone in a heterogeneous network may operate in substantial compliance with Release 8 of the 3GPP standards while another mobile phone may operate in substantial compliance with Release 10 of the 3GPP standards, and so on.

Because of the introduction of the low power node or nodes, heterogeneous networks may experience increased interference. The interference may be particularly acute for control channels, such as the downlink control channel.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Embodiments contemplate a wireless transmit/receive unit (WTRU) that may be configured, at least in part, to detect the presence of an extended physical downlink control channel (E-PDCCH) and to decode a physical downlink control channel (PDCCH) upon detecting the E-PDCCH. Embodiments also contemplate that the WTRU may be configured to obtain scheduling information of the E-PDCCH on a physical downlink shared control channel (PDSCH) from the decoded PDCCH. Also, the WTRU may be configured to determine control information for the WTRU from the E-PDCCH using the scheduling information of the E-PDCCH. Embodiments contemplate that the WTRU may operate in a heterogeneous wireless communication network (HetNet).

Embodiments also contemplate that the HetNet may further include a first evolved-Node B (first eNB) and a second evolved-Node B (second eNB), and that both the first eNB and the second eNB may be within wireless communication range of the WTRU. Embodiments further contemplate that the WTRU may receive the E-PDCCH from the first eNB and may receive another E-PDCCH from the second eNB. The other E-PDCCH may be coordinated with the E-PDCCH such that the interference between the other E-PDCCH and the E-PDCCH from the perspective of the WTRU may be reduced relative to no coordination of the E-PDCCH and the other E-PDCCH. Embodiments also contemplate that the first eNB may be a macro base station (MeNB) and the second eNB may be a home base station (HeNB).

Embodiments contemplate a method that may be performed by a wireless transmit/receive unit (WTRU). The method may comprise detecting the presence of an extended physical downlink control channel (E-PDCCH) and decoding a physical downlink control channel (PDCCH) upon detecting the E-PDCCH. The method may also include obtaining scheduling information of the E-PDCCH on a physical downlink shared control channel (PDSCH) from the decoded PDCCH. Embodiments further contemplate that the method may include determining control information for the WTRU from the E-PDCCH using the scheduling information of the E-PDCCH.

Embodiments also contemplate that the detecting the presence of E-PDCCH may include determining a master information block (MIB) bit corresponding to the E-PDCCH. Additionally, embodiments contemplate that the detecting the presence of E-PDCCH may include determining a system information block (SIB) bit corresponding to the E-PDCCH. Embodiments further contemplate that the scheduling information of the E-PDCCH may be obtained by decoding downlink control information (DCI) from the decoded PDCCH.

Embodiments contemplate that an evolved-Node B (eNB) may be configured, at least in part to provide an extended physical downlink control channel (E-PDCCH) and to provide the E-PDCCH on a physical downlink shared control channel (PDSCH). The eNB may also be configured to provide scheduling information for the E-PDCCH on the PDSCH on a physical downlink control channel (PDCCH). Embodiments further contemplate that the PDCCH may include downlink control information (DCI) that may indicate the scheduling information of the E-PDCCH on the PDSCH. The scheduling information may include at least one of an Nstart, Nend, or resource block (RB) assignment information.

Embodiments also contemplate that the eNB may be further configured to coordinate scheduling of one or more physical downlink control channels with another evolved-Node (eNB), where the eNB and the other eNB may have respective coverage areas that overlap, at least in part.

Embodiments also contemplate that a wireless system may be configured to reduce downlink control channel interference. The wireless system may include a Macro eNode B (MeNB) and a Home eNode B (HeNB). The MeNB may have a coverage area that overlaps that of the HeNB. The MeNB and the HeNB may be configured to have coordinated scheduling of respective Physical Downlink Control Channels.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D depicts example interference scenarios in a heterogeneous network consistent with embodiments;

FIG. 2 illustrates an example FDM-based and a hybrid FDM/TDM-based schemes for E-PDCCH consistent with embodiments;

FIG. 3 depicts exemplary usage of E-PDCCH consistent with embodiments;

FIG. 4 depicts exemplary mappings of E-PDCCH consistent with embodiments;

FIG. 5 depicts exemplary embodiments implemented by a wireless transmit/receive device; and

FIG. 6 depicts exemplary embodiments implemented by an evolved Node-B (eNB).

### DETAILED DESCRIPTION

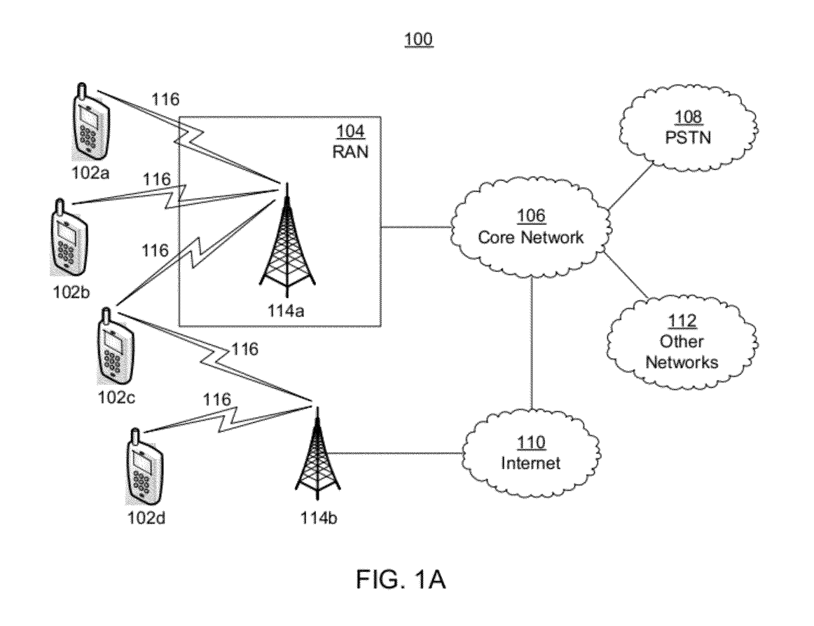

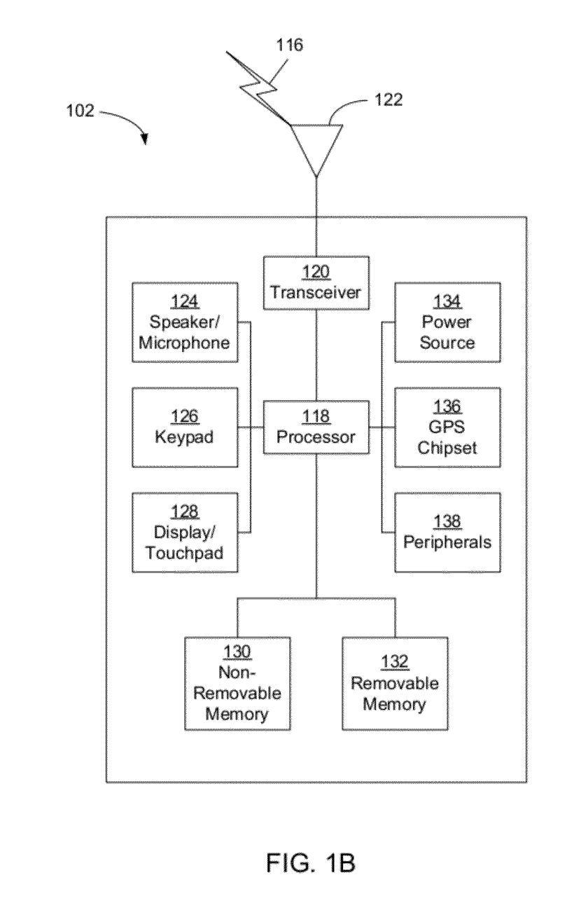

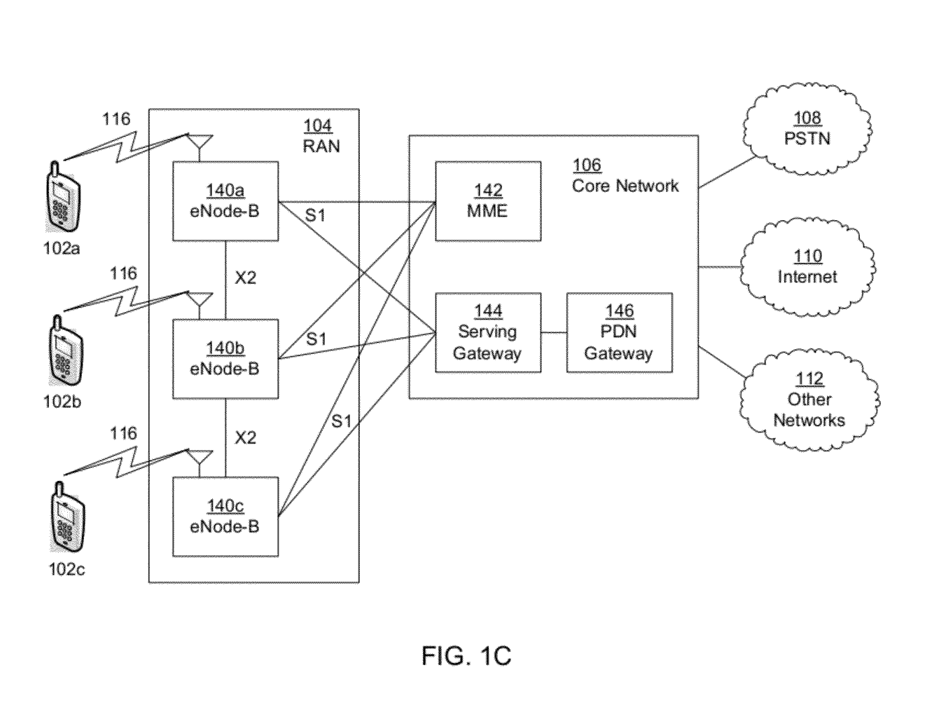

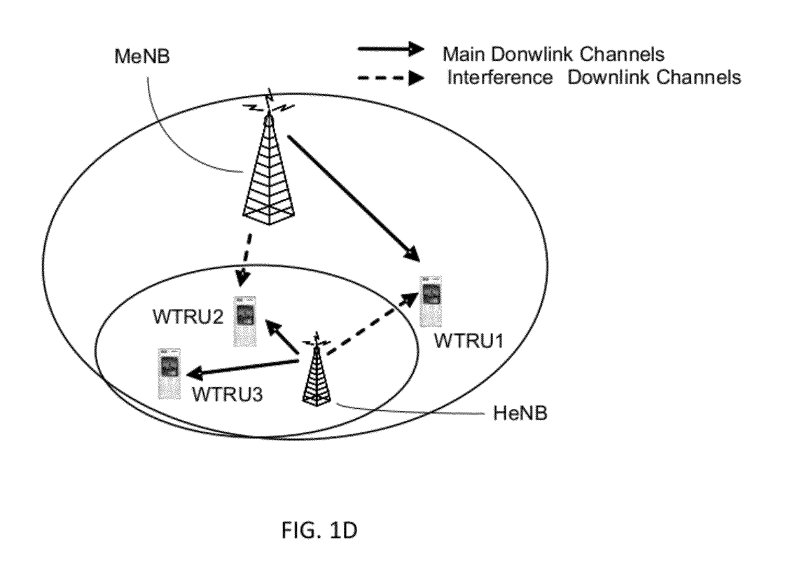

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, and/or 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, and/or 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, and/or 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

When referred to hereafter, the terminology “wireless transmit/receive unit (WTRU)” includes but is not limited to a user equipment (UE), a mobile station, a station (STA), a fixed or mobile subscriber unit, a pager, a cellular telephone, a personal digital assistant (PDA), a computer, or any other type of device capable of operating in a wireless environment. When referred to hereafter, the terminology “base station” includes but is not limited to a Node-B, a site controller, an access point (AP), or any other type of interfacing device capable of operating in a wireless environment.

Embodiments contemplate that interference in heterogeneous networks may be particularly acute for control channels. For example, control channels may be confined to a reduced control region that spans a whole band. Embodiments contemplate that extended physical download control channel (E-PDCCH) may be used for mitigating the interference on downlink control channel in a Heterogeneous Network (HetNet), for example. The contemplated downlink CCH scheme may result in a reduced amount of interference, or perhaps the least amount of interference, in a HetNet system.

Some long term evolution (LTE) downlink designs may not have support for orthogonal PDCCH operations for Macro-eNB (MeNB) and Home-eNB (HeNB) in a HetNet system. In such situations, as the result of interference, the downlink control channel performance may be affected. By way of example, and not limitation, techniques based on time and frequency staggering may enable coexistence of MeNB and HeNB PDCCH's.

As illustrated in FIG. 1D, the desire may be appreciated to protect PDCCH reception of M-WTRU's (WTRU1) from the interfering (or “the other”) PDCCH of the close-by HeNB, to protect PDCCH reception of H-WTRU's (WTRU2) from the interfering PDCCH of the MeNB, and/or to support PDCCH service to legacy release 8 (R-8) WTRU's (WTRU3) in a HeNB.

Embodiments contemplate that extended PDCCH (E-PDCCH) may be applied to heterogeneous networks deployment. For example, in each subframe, a new PDCCH region may be defined within the physical downlink shared channel (PDSCH) domain. Then, the HeNB PDCCH may be fully or partially protected. For full protection, MeNB and HeNB may coordinate resource block (RB) scheduling for E-PDCCH to, perhaps completely, avoid interference with MeNB PDSCH payload. Embodiments contemplate that the partial protection may be used without coordination between the MeNB and HeNB. Because PDSCH from MeNB and/or HeNB can be transmitted in localized RBs instead of spread over the entire BW means that interference may be avoided or mitigated on E-PDCCH. Embodiments further contemplate that the E-PDCCH region may be defined in a number of different ways.

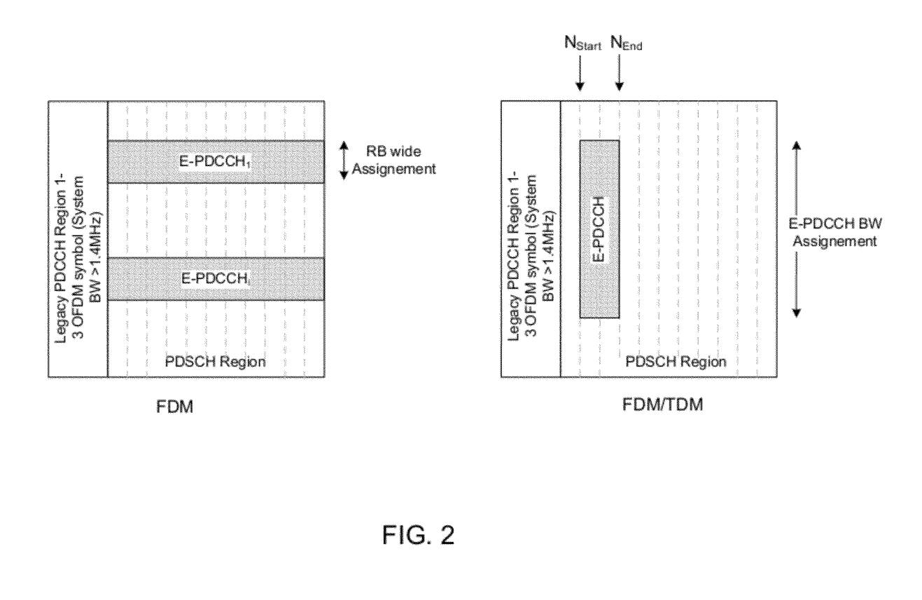

FIG. 2 illustrates example frequency domain multiplexing (FDM)-based and hybrid frequency domain multiplexing/time domain multiplexing (FDM/TDM)-based schemes for E-PDCCH. In FDM-based embodiments, full RB-based assignments may be used for E-PDCCH. In FDM/TDM-based embodiments, at least some of the available frequency and time resources in a subframe may be used. In either scheme, HeNB WTRUs may be required to know the location information E-PDCCH region, perhaps without relying on reading physical control format indication channel (PCFICH) information. Contemplated proper conventions and/or mechanisms may facilitate such operation.

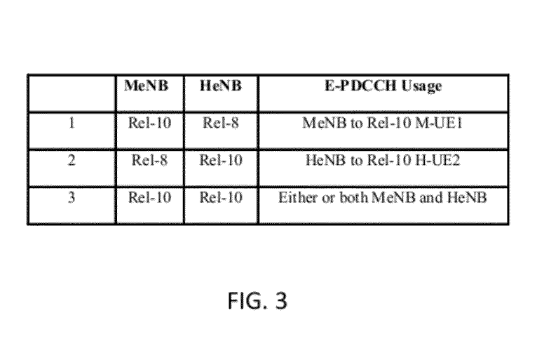

FIG. 3 illustrates the use of E-PDCCH for three example scenarios, but embodiments are not limited to these example scenarios. Embodiments contemplate that the E-PDCCH concept may be employed by either a MeNB or HeNB, or both. For example, the E-PDCCH can either be transmitted by the Macro eNB, the HeNB, or by both. The macro eNB may transmit the E-PDCCH (identified as row 1). Additionally or alternatively, the HeNB may transmit the E-PDCCH (identified as row 2).

The desirability may be appreciated to protect PDCCH reception of M-WTRU's (illustrated as WTRU1 in FIG. 1D) from the interfering PDCCH of the close-by HeNB. For example, WTRU1 may be close to the HeNB, but it may not be in a closed subscriber group (CSG) associated with HeNB. For example, WTRU1 may need to connect to the macro eNB (MeNB). Interference from HeNB may prevent WTRU1 from receiving control channel from macro eNB.

Embodiments contemplate that the macro eNB may send E-PDCCH (e.g., control in PDSCH region). By way of example, for full protection, the HeNB may coordinate its downlink (DL) scheduling with MeNB. The HeNB may avoid using the RBs used by the Macro E-PDCCH. Except perhaps for the interference caused by HeNB cell-specific reference signals (CRSs), most other interference may be eliminated. Also by way of example, for partial protection, the HeNB may not coordinate its DL scheduling with MeNB. In addition to the interference caused by HeNB CRSs, there may be some limited HeNB PDSCH interference to the E-PDCCH received by M-WTRU1.

Alternatively or additionally, the HeNB may send E-PDCCH (e.g., control in PDSCH region) to Rel-10 H-WTRUs. For example, for full protection, the HeNB may coordinate its DL scheduling with MeNB. The HeNB may transmit some or most of its control information to some or all WTRUs in the PDSCH region in order to avoid interfering with MeNB PDSCH and/or MeNB PDCCH in the normal control region.

Embodiments contemplate that a WTRU in bad geometry (e.g., low SINR from serving cell) may need protection on its PDCCH. An LTE Rel-8 eNB may transmit PDCCH with large aggregation level (e.g., strong coding rate) to such a WTRU. For example, the largest aggregation level defined for LTE R-8/9/10 may be N=8. Embodiments contemplate that the use of E-PDCCH to a WTRU may be limited to PDCCH with aggregation level larger than N. For example, a WTRU may search downlink control channel with aggregation level no greater than N in the regular PDCCH region, and search downlink control channel with aggregation level greater than N in PDSCH region.

The desirability may be appreciated to protect PDCCH reception of H-WTRUs (illustrated as WTRU2 in FIG. 1D) from the interfering PDCCH of the MeNB. WTRU2 may want to maintain its connection to HeNB. Embodiments contemplate that the interference from MeNB PDCCH may prevent WTRU2 from interference-free reception of control channel from HeNB, for example.

Embodiments contemplate that the Macro eNB may send E-PDCCH (e.g., control in PDSCH region). For example, for full protection, the MeNB may send most of its control information to all WTRUs in the PDSCH region in order to, perhaps significantly, reduce interference. The HeNB may be informed to avoid using the PDSCH resources used by MeNB E-PDCCH. Also by way of example, for partial protection, the MeNB may send some or most of its control information to some or all WTRUs in the PDSCH region in order to, perhaps significantly, reduce interference. The HeNB may not be required to coordinate its PDSCH usage with MeNB.

Embodiments also contemplate that the HeNB may send E-PDCCH (e.g., control in PDSCH region). For example, for full protection, the HeNB may send E-PDCCH information in the PDSCH resources that are permitted by Macro eNB, and in some embodiments perhaps only in the PDSCH resources that are permitted by Macro eNB. By way of example, for partial protection, the HeNB may send E-PDCCH information with little, or perhaps without any, coordination with MeNB for PDSCH scheduling.

Embodiments contemplate that a WTRU in bad geometry (e.g., low SINR from serving cell) may need protection on its PDCCH. A LTE Rel-8 eNB may transmit PDCCH with large aggregation level (e.g., strong coding rate) to such a WTRU. The use of E-PDCCH to a WTRU may be limited to PDCCH with aggregation level larger than N. For example, embodiments contemplate that a WTRU may search downlink control channel with aggregation level no greater than N in the regular PDCCH region, and may search downlink control channel with aggregation level greater than N in PDSCH region.

The desirability may be appreciated to support PDCCH service to legacy R-8 WTRU's (illustrated as WTRU3 in FIG. 1) in a HeNB. WTRU3 may be an R-8 WTRU that attempts to connect to the R-10 HeNB that is using E-PDCCH for transmitting its control information. Because an R-8 WTRU may not be capable of processing E-PDCCH, it would typically not connect to the R-10 HeNB.

Embodiments contemplate that the R-10 HeNB may transmit some or all the required control channel information including, but not limited to: physical hybrid automatic repeat request indicator channel (PHICH), PCFICH, and/or PDCCH for the R-8 H-WTRU at the regular dedicated region for control channel signaling. The overall power of the transmitted PDCCH may be limited to support R-8 WTRU's. If no R-8 WTRU is present in the cell, then embodiments contemplate that the R-10 HeNB can completely mute PDCCH transmission. Upon reading the Closed Subcarrier Group identification (CSG-ID) that is broadcast in system information, R-8 WTRUs may proceed for cell (re)selection, such as by an R-8 WTRU cell (re)selection procedure.

Embodiments contemplate that E-PDCCH may be transmitted by HeNB carrying some or all of the required control related information for some or all HeNB WTRUs. E-PDCCH may be transmitted on OFDM symbols that may not be used by MeNB for PDCCH transmission, e.g., E-PDCCH may be mapped to PDSCH resources.

Embodiments contemplate that implementation of the E-PDCCH may include one or more procedures. For example, an implementation of the E-PDCCH may include a procedure for the initial connection according to the E-PDCCH usage. The WTRU may connect to the cell. When the WTRU reads the physical broadcast channel (PBCH), the WTRU may indicate which control channel (PDCCH or E-PDCCH) should be used to read the system information blocks (SIBs). If the E-PDCCH is used by HeNbs, then it is likely that some or all the R10 WTRUs connecting to the cell would use the E-PDCCH. In this case, the control channel may be indicated by using a field of, for example, 1-3 bits in the PBCH (perhaps using existing spare bits) to indicate where the control channel is located and also the size of the control channel, for example, in physical resource blocks (PRB's). By way of example, R8/9 WTRUs may ignore this field and use the PDCCH to read the SIBs. Also by way of example, R10 WTRUs may use this field to determine which control channel to use.

By way of example, and not limitation, code 0 may indicate that PDCCH is to be used. Each other code may indicate that the E-PDCCH is to be used. Codes may indicate a particular pre-determined location in time and/or frequency for the E-PDCCH channel. A number of central RBs may be defined for the location of the control region. Also, each code may indicate a size of the control region. Alternatively or additionally, equally spaced PRB's may be defined in the frequency domain. Alternatively or additionally, bits in the PBCH may be coded such that one bit may indicate that the eNB is an R10 eNB (this indication could be used by the WTRU to infer the presence of other R10 functionality) and the other bits may indicate whether or not the E-PDCCH is to be used.

Embodiments contemplate that if macro cells could also use the E-PDCCH, the macro cells may define a mechanism to allow some WTRUs to use the E-PDCCH while others may use the PDCCH to read the SIBs. In such a scenario, the same mechanism described previously could be used, but the WTRUs may attempt to read the PBCH by looking for grants both in the PDCCH and in the E-PDCCH.

Whether future grants would be transmitted in the PDCCH or the E-PDCCH may be indicated to the WTRU. Embodiments contemplate that the RACH response may be used. Alternatively or additionally, a page (transmitted in the common search space, so either in PDCCH or E-PDCCH) may be used. The SIBs may include pointers to additional WTRU-specific control regions.

Embodiments contemplate that the initial WTRU access, including system acquisition and the random access procedure, may be done using the legacy PDCCH. Once the WTRU is connected to the network, the network may then signal to the WTRU using semi-static signaling (radio resource control (RRC), system information broadcast (SIB)) what type of control region to use, e.g., a PDCCH control region or an E-PDCCH region, or both. The network (Macro NB or eNB) can switch specific WTRU (with support for E-PDCCH) between control region types, e.g., PDCCH region versus E-PDCCH region as needed based on the network scheduler decision. The switching between control region types can also be based on a predefined pattern communicated to the WTRU ahead of time using RRC or SIB, for example. The network can also assign (via RRC or SIB) both the PDCCH and the E-PDCCH control regions simultaneously or near-simultaneously to the same WTRU. An example of the usage of such assignment may include assigning common search space in the PDCCH region while assigned WTRU specific search space in the E-PDCCH region. The E-PDCCH capable WTRUs may autonomously, and perhaps blindly in some embodiments, decode both the PDCCH and e-PDCCH search spaces with little or perhaps no explicit signaling from the network on which control channel type to use.

Embodiments also contemplate that, for E-PDCCH capable WTRUs, the information to locate and decode SIBs may be transmitted using either E-PDCCH or PDCCH, and in some embodiments always using either E-PDCCH or PDCCH. Alternatively, the information to locate and decode SIBs may be transmitted using E-PDCCH, and in some embodiments always using the E-PDCCH. Alternatively, this information may be transmitted using PDCCH, and in some embodiments, always using the PDCCH.

Alternatively or additionally, embodiments contemplate that, for the purpose of reading of SIBs by an R-10 WTRU or beyond, a different system information radio network temporary identifier (SI-RNTI, e.g., non-R8 SI-RNTI) may be defined for R-10 WTRUs (or beyond) which points to the PDSCH that has the SIBs for such WTRUs. Thus, the legacy PDCCH may carry such information that may be scrambled with the new SI-RNTI. The R-10 WTRUs may use other indications to know whether or not this new SI-RNTI may be used (e.g. based on indications from the MIB as described previously). Or the R-10 WTRUs can try to decode the PDCCH based on the new SI-RNTI and if successful, the WTRUs can know that an E-PDCCH channel may exist in the cell. The WTRUs may read the SIBs in the PDSCH and may use that information for further functionality with regards to the E-PDCCH. When using the E-PDCCH, the radio link failure (RLF) may be defined so it looks at region for E-PDCCH.

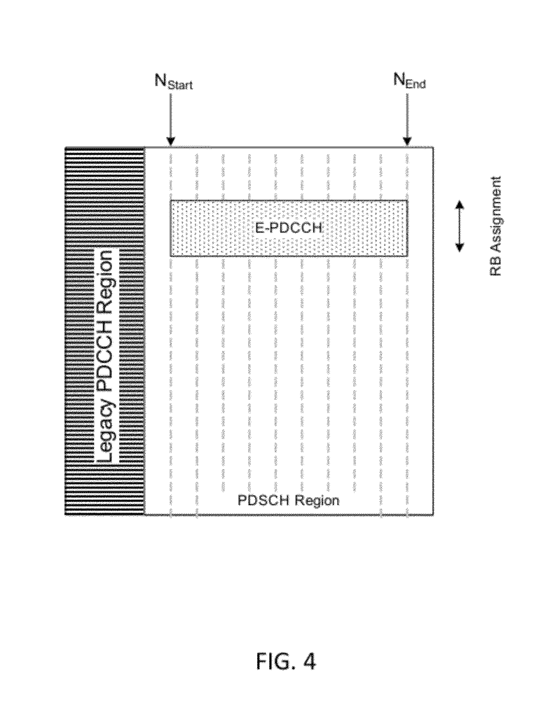

Alternatively or additionally, embodiments contemplate that the WTRU may detect the presence of the E-PDCCH by checking a corresponding bit in the MIB. For example, such information may be flagged by one bit, or perhaps more than one bit. Upon detection of the E-PDCCH support, the WTRU may perform decoding of the legacy PDCCH, in some embodiments perhaps blind decoding, to decode a DCI payload carrying the PDSCH scheduling information of E-PDCCH. Referring to FIG. 4, the DCI payload carrying the PDSCH scheduling information may be a DCI payload heretofore unused, and may include E-PDCCH scheduling information such as, but not limited to Nstart, Nend, and RB assignment information. By using the PDSCH scheduling information of E-PDCCH, the WTRU may extract the E-PDCCH information to derive some or all of the common and/or WTRU specific control information that may include information such as: downlink/uplink scheduling assignments, PDSCH/PUSCH resources indication, HARQ parameters, uplink scheduling grants, power control commands, among other information.

Alternatively or additionally, embodiments contemplate that the WTRU may perform decoding of the legacy PDCCH, and in some embodiments perhaps blind decoding, to decode the DCI payload indicating presence of E-PDCCH support and the corresponding PDSCH scheduling information of E-PDCCH. The DCI payload carrying the PDSCH scheduling information may be a DCI payload heretofore unused, and may carry a flag bit indicating presence of E-PDCCH support and the corresponding PDSCH scheduling information of E-PDCCH. The E-PDCCH scheduling information may include, but is not limited to Nstart, Nend, and RB assignment information as shown in FIG. 4. By using the PDSCH scheduling information of E-PDCCH, the WTRU may extract the E-PDCCH information to derive some or all the common and/or WTRU specific control information that may include information such as: downlink/uplink scheduling assignments, PDSCH/PUSCH resources indication, HARQ parameters, uplink scheduling grants, power control commands, among other information.

Embodiments contemplate that certain features may facilitate the detection and characterization of the E-PDCCH support in a HetNet. For example, the addition of an extra bit to the Master Information Block (MIB) may be used, such as at least one bit to detect the presence of the E-PDCCH support. Alternatively or additionally, embodiments contemplate the addition of extra bits to the System Information Block (SIB) may be used, such as at least one bit to detect the presence of the E-PDCCH support and/or two to four bits to carry the location and scheduling information of the E-PDCCH block, for example.

E-PDCCH may span across the entire space of a PRB(s). The involved PRB's for E-PDCCH can be localized or distributed, for example. The E-PDCCH payload may use a channel coding and rate matching procedure (such as, but not limited to, the R-8 channel coding and rate matching procedure) to fit in the allocated resource locations.

Embodiments contemplate one or more mapping schemes for E-PDCCH resource allocation. The mapping schemes may include fixed location mapping and/or dynamic location mapping, for example. In fixed location mapping, fixed resource locations per subframe, such as some numbers of central RBs, may be allocated for the control region. Upon detection of the E-PDCCH support, a WTRU may go (directly for example) to the pre-defined location to access to the E-PDCCH information. In an alternative scheme, where there may be no information to indicate the presence of the E-PDCCH, a WTRU may attempt to blindly decode the presence and the content of the E-PDCCH by decoding the information received in the predefined location. Alternatively or additionally, equally spaced PRB's in the frequency domain may also be defined. The WTRU may be able to identify these locations by knowing system bandwidth read from MIB, and in some embodiments by perhaps only knowing system bandwidth read from MIB.

In dynamic location mapping, the resource location may change semi-statically according to the information provided by SIB. Also, the resource location may change according to the information provided by RRC signaling. Further, the resource location may change according to the information decoded from a DCI payload, and/or the like.

Embodiments contemplate that in FDM mapping, one or several PRB's may be allocated for E-PDCCH. The starting symbol of the E-PDCCH may be used. By way of example, and not limitation, the starting symbol of the E-PDCCH may be fixed to the 4th OFDM symbol that may be the latest possible location for the OFDM symbol carrying the PDSCH for system bandwidths of >1.4 MHz.

Alternatively or additionally, the starting symbol of E-PDCCH may be configurable. The starting symbol may be broadcast in MeNB SIB, where each CGS ID could be assigned a different OFDM symbol number as the starting E-PDCCH symbol. Also, the E-PDCCH may be located blindly by the HeNB WTRU.

Embodiments contemplate that in hybrid FDM/TDM mapping, PDSCH resources can be assigned for E-PDCCH operation. For example, control channel elements (CCEs) can be of different lengths. In case of a partial mapping/use of frequency resources, a CCE may be either spanned over two OFDM symbols or the leftover unused frequency resources declared as nulls, for example. Alternatively or additionally, the mapping may be localized or distributed mapping in which interleaving can be used permanently or on a configured-based to exploit frequency diversity.

Embodiments contemplate that a PHICH process (such as but not limited to the R-8 PHICH process) may be employed within the available region of the E-PDCCH. Also, in situations in which the number of WTRU's per HeNB may be small, embodiments contemplate that no separate E-PCFICH signaling may be required. Also, the size of E-PDCCH payload may be derived from the PDSCH scheduling information for E-PDCCH.

Embodiments contemplate that for release 8 (R8) WTRUs, radio link failure may be based on the channel condition over the full bandwidth. With the system and methods described herein, the WTRU may receive a limited bandwidth to correctly receive the control channel, and in some embodiments the WTRU may only need to receive a limited bandwidth to correctly receive the control channel. Interference over part of the bandwidth may not prevent communication between the eNB and the WTRU. As such, the radio link failure criteria for WTRU's receiving control data over the E-PDCCH may be defined accordingly. For example, the demodulation reference signal (DM-RS) may be used for radio link quality estimation. The DM-RS pilots can be precoded either by the same transmission scheme as the E-PDCCH payload or an identity matrix (for example, no beamforming) Also for example, R-8 CRS can also be used for radio link failure assessment.

Embodiments contemplate that during intra-EUTRAN mobility, the WTRU, after receiving the handover command, may start synchronization with the new cell/eNB and then perform initial random access. The WTRU may need to monitor the PDCCH for the random access response (RAR). The handover can be such that the R10 WTRU is moving from R8 to R10 eNB, or from R10 to R8 eNB, or from R10 to R10 eNB (note that eNB herein can refer to both macro eNB or HeNB).

The control channel may be monitored for a random access response. For example, regardless of the source's/target's eNB release version, the WTRU may monitor the legacy PDCCH for the random access response (RAR). The WTRU may be configured such that this is the default rule unless informed to do otherwise. Alternatively or additionally, the E-PDCCH-capable WTRUs may detect the presence of a channel (perhaps a new channel) using the presence of E-PDCCH indicator bit or bits in the MIB.

Alternatively or additionally, the WTRU may be informed about the release version of the target eNB and may know ahead of time where the RAR is expected (e.g., on legacy PDCCH or on E-PDCCH). For example, the WTRU can by default assume that if the target eNB is R10, then the RAR is expected on the E-PDCCH. Also, the WTRU may be informed if the legacy PDCCH or the E-PDCCH is to be monitored even if the release version of the target eNB is R10. Additionally, the WTRU may be informed about the type of control channel—PDCCH or E-PDCCH—to use without explicit indication of the release version of the eNB, for example.

Alternatively or additionally, embodiments contemplate that for contention-free random access, the WTRU may use the preamble provided by the source eNB to determine if the PDCCH and/or the E-PDCCH should be used in the target cell. For example, a set of preambles may be reserved for use in conjunction with the E-PDCCH.

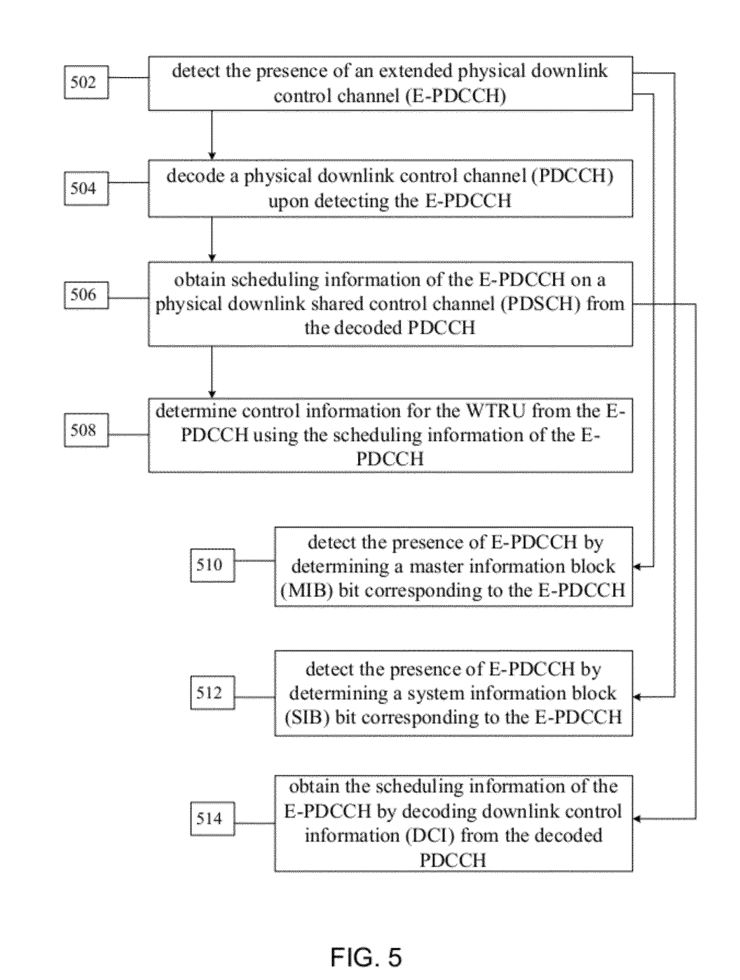

In light of the previous description and also FIGS. 1-4, and referring to FIG. 5, embodiments contemplate that a wireless transmit/receive unit (WTRU) may be configured, at least in part, to, at 502, detect the presence of an extended physical downlink control channel (E-PDCCH) and, at 504, to decode a physical downlink control channel (PDCCH) upon detecting the E-PDCCH. Embodiments also contemplate that, at 506, the WTRU may be configured to obtain scheduling information of the E-PDCCH on a physical downlink shared control channel (PDSCH) from the decoded PDCCH. At 508, the WTRU may be configured to determine control information for the WTRU from the E-PDCCH using the scheduling information of the E-PDCCH. Embodiments contemplate that the WTRU may operate in a heterogeneous wireless communication network (HetNet).

Alternatively or additionally, embodiments contemplate that the HetNet may further include a first evolved-Node B (first eNB) and a second evolved-Node B (second eNB), and that both the first eNB and the second eNB may be within wireless communication range of the WTRU. Embodiments further contemplate that the WTRU may receive the E-PDCCH from the first eNB and may receive another E-PDCCH from the second eNB. Alternatively or additionally, the other E-PDCCH may be coordinated with the E-PDCCH such that the interference between the other E-PDCCH and the E-PDCCH from the perspective of the WTRU may be reduced relative to no coordination of the E-PDCCH and the other E-PDCCH. Embodiments also contemplate that the first eNB may be a macro base station (MeNB) and the second eNB may be a home base station (HeNB). Alternatively or additionally, at least one of the E-PDCCH or the PDCCH may be provided by the MeNB.

At 510, the WTRU may be further configured to detect the presence of E-PDCCH by determining a master information block (MIB) bit corresponding to the E-PDCCH. Alternatively or additionally, at 512, the WTRU may be further configured to detect the presence of E-PDCCH by determining a system information block (SIB) bit corresponding to the E-PDCCH.

Alternatively or additionally, embodiments further contemplate that, at 514, the scheduling information of the E-PDCCH may be obtained by decoding downlink control information (DCI) from the decoded PDCCH. Embodiments contemplate that the decoded DCI may include the scheduling information, and that the scheduling information may include at least one of an Nstart, Nend, or resource block (RB) assignment information.

Alternatively or additionally, embodiments contemplate that the decoding of the physical downlink control channel (PDCCH) may be blind. Also, embodiments contemplate that the control information for the WTRU may include at least one of common control information or WTRU specific control information.

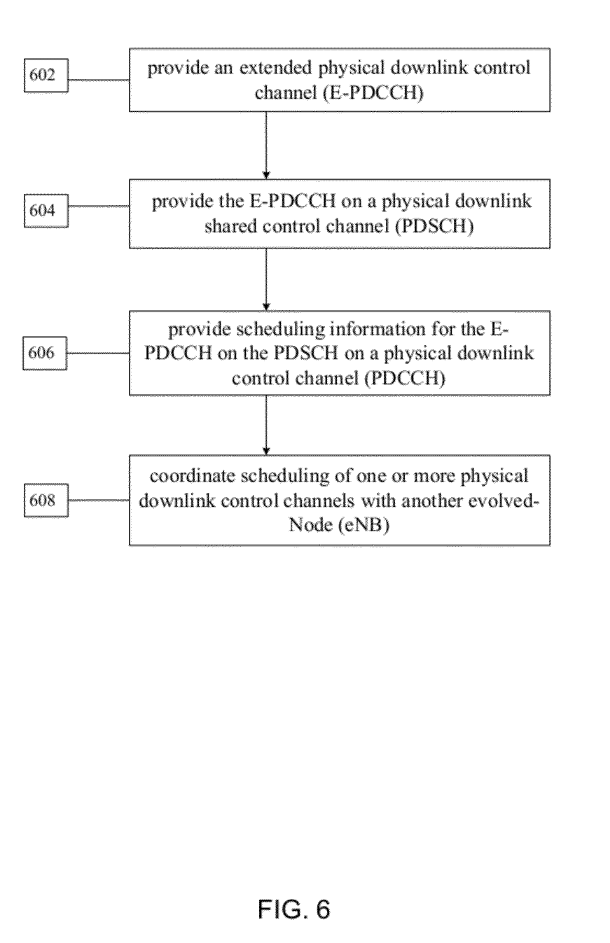

Referring to FIG. 6, embodiments contemplate that an evolved-Node B (eNB) may be configured, at least in part, at 602, to provide an extended physical downlink control channel (E-PDCCH). At 604, the eNB may be configured to provide the E-PDCCH on a physical downlink shared control channel (PDSCH), and, at 606, to provide scheduling information for the E-PDCCH on the PDSCH on a physical downlink control channel (PDCCH). Embodiments further contemplate that the eNB may include downlink control information (DCI) in the PDCCH that indicates the scheduling information of the E-PDCCH on the PDSCH, and that the scheduling information may include at least one of an Nstart, Nend, or resource block (RB) assignment information.

Embodiments further contemplate that, at 608, the eNB may be further configured to coordinate scheduling of one or more physical downlink control channels with another evolved-Node (eNB), where the eNB and the other eNB may have respective coverage areas that overlap, at least in part.

While the various embodiments have been described in connection with the various figures, it is to be understood that other similar embodiments may be used or modifications and additions may be made to the described embodiment for performing the same function of the various embodiments without deviating there from. Therefore, the embodiments should not be limited to any single embodiment, but rather should be construed in breadth and scope in accordance with the appended claims.

Although features and elements are described above in particular combinations, it may be appreciated that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A wireless transmit/receive unit (WTRU) configured, at least in part, to:
detect the presence of an extended physical downlink control channel (E-PDCCH);
decode a physical downlink control channel (PDCCH) upon detecting the E-PDCCH;
obtain scheduling information of the E-PDCCH on a physical downlink shared control channel (PDSCH) from the decoded PDCCH; and
determine control information for the WTRU from the E-PDCCH using the scheduling information of the E-PDCCH.

2. The WTRU of claim 1, wherein the WTRU operates in a heterogeneous wireless communication network (HetNet).

3. The WTRU of claim 3, wherein the HetNet further includes a first evolved-Node B (first eNB) and a second evolved-Node B (second eNB), both the first eNB and the second eNB being within wireless communication range of the WTRU.

4. The WTRU of claim 3, wherein the WTRU receives the E-PDCCH from the first eNB and receives another E-PDCCH from the second eNB, the other E-PDCCH coordinated with the E-PDCCH such that the interference between the other E-PDCCH and the E-PDCCH from the perspective of the WTRU is reduced relative to no coordination of the E-PDCCH and the other E-PDCCH.

5. The WTRU of claim 4, wherein the first eNB is a macro base station (MeNB) and the second eNB is a home base station (HeNB).

6. The WTRU of claim 5, wherein at least one of the E-PDCCH or the PDCCH is provided by the MeNB.

7. The WTRU of claim 1, wherein the WTRU is further configured to detect the presence of E-PDCCH by determining a master information block (MIB) bit corresponding to the E-PDCCH.

8. The WTRU of claim 1, wherein the WTRU is further configured to detect the presence of E-PDCCH by determining a system information block (SIB) bit corresponding to the E-PDCCH.

9. The WTRU of claim 1, wherein the scheduling information of the E-PDCCH is obtained by decoding downlink control information (DCI) from the decoded PDCCH.

10. The WTRU of claim 9, wherein the decoded DCI includes the scheduling information, the scheduling information including at least one of an Nstart, Nend, or resource block (RB) assignment information.

11. The WTRU of claim 1, wherein the decoding of the physical downlink control channel (PDCCH) is blind.

12. The WTRU of claim 1, wherein the control information for the WTRU includes at least one of common control information or WTRU specific control information.

13. A method performed by a wireless transmit/receive unit (WTRU), the method comprising:
detecting the presence of an extended physical downlink control channel (E-PDCCH);
decoding a physical downlink control channel (PDCCH) upon detecting the E-PDCCH;
obtaining scheduling information of the E-PDCCH on a physical downlink shared control channel (PDSCH) from the decoded PDCCH; and
determining control information for the WTRU from the E-PDCCH using the scheduling information of the E-PDCCH.

14. The method of claim 13, wherein the WTRU operates in a heterogeneous wireless communication network (HetNet), and the HetNet further includes a first evolved-Node B (first eNB) and a second evolved-Node B (second eNB), both the first eNB and the second eNB being within wireless communication range of the WTRU, and the method further including:
receiving the E-PDCCH from the first eNB and receiving another E-PDCCH from the second eNB, the other E-PDCCH coordinated with the E-PDCCH such that the interference between the other E-PDCCH and the E-PDCCH from the perspective of the WTRU is reduced relative to no coordination of the E-PDCCH and the other E-PDCCH.

15. The method of claim 13, wherein the detecting the presence of E-PDCCH includes determining a master information block (MIB) bit corresponding to the E-PDCCH.

16. The method of claim 13, wherein the detecting the presence of E-PDCCH includes determining a system information block (SIB) bit corresponding to the E-PDCCH.

17. The method of claim 13, wherein the scheduling information of the E-PDCCH is obtained by decoding downlink control information (DCI) from the decoded PDCCH.

18. An evolved-Node B (eNB) configured, at least in part to:
provide an extended physical downlink control channel (E-PDCCH);
provide the E-PDCCH on a physical downlink shared control channel (PDSCH); and
provide scheduling information for the E-PDCCH on the PDSCH on a physical downlink control channel (PDCCH).

19. The eNB of claim 18, wherein the PDCCH includes downlink control information (DCI) that indicates the scheduling information of the E-PDCCH on the PDSCH, the scheduling information including at least one of an Nstart, Nend, or resource block (RB) assignment information.

20. The eNB of claim 18, wherein the eNB is further configured to coordinate scheduling of one or more physical downlink control channels with another evolved-Node (eNB), the eNB and the other eNB having respective coverage areas that overlap, at least in part.
